(19) United States
(12) Patent Application Publication
(10) Pub. No.: US 2022/0259524 A1
(43) Pub. Date: Aug. 18, 2022

(54) PERFUMED CONSUMER PRODUCTS

(71) Applicant: FIRMENICH SA, Satigny (CH)

(72) Inventors: Arnaud STRUILLOU, Satigny (CH); Estelle RASSAT, Satigny (CH)

(21) Appl. No.: 17/621,789

(22) PCT Filed: Jun. 26, 2020
(86) PCT No.: PCT/EP2020/068046

§ 371 Date: Dec. 22, 2021

(30) Foreign Application Priority Data
Jun. 27, 2019 (EP) 19182885.4

(51) Int. Cl. C11D 3/50; C11D 3/20; C11D 3/386

(52) U.S. Cl. CPC C11D 3/507; C11D 3/38627; C11D 3/2093; C11D 3/505

(57) ABSTRACT

Described herein is a perfumed consumer product including a pro-perfume compound and a trigger, where the pro-perfume compound and the trigger are physically separated from each other by including the pro-perfume compound or the trigger in a particle, the pro-perfume compound and the trigger in different particles or the pro-perfume compound and the trigger in different compartments. Also described herein are methods of using said perfumed consumer product to confer, enhance, improve or modify a perfuming effect of an article.

### TECHNICAL FIELD

The present invention relates to a perfumed consumer product comprising a pro-perfume compound and a trigger, wherein the pro-perfume compound and the trigger are physically separated from each other by comprising the pro-perfume compound or the trigger in a particle, the pro-perfume compound and the trigger in different particles or the pro-perfume compound and the trigger in different compartments as well as uses or methods of said perfumed consumer product to confer, enhance, improve or modify a perfuming effect of an article.

### BACKGROUND OF THE INVENTION

Pro-perfume compounds are known to a skilled person and provide a release of a perfuming ingredient, in particular an olfactive perfuming ingredient, upon trigger with an external stimulus, such as upon contact with moisture and/or exposure to light and/or increased temperature and/or oxidative environment and/or an activating agent and a certain control of the kinetics of fragrance release to induce sensory effects through sequential release.

The labile nature of pro-perfume compounds towards certain triggers, however, provides problems with regard to stability of the pro-perfume compound, controlled release of the pro-perfume compounds with the trigger and longevity of the olfactive effect in certain applications. Exemplary, in case a pro-perfume compound prematurely contacts or reacts with its corresponding trigger, the pro-perfume compounds prematurely release the perfuming ingredient so that the perfuming effect is prematurely provided, i.e. but is available for an extended period of time or at the defined moment when needed. This is a particular problem for applications of enzyme cleavable pro-perfume compounds in case of the presence of an enzyme, such as laundry detergents.

An object of the present invention is to provide a perfumed consumer product providing improved compatibility of pro-perfume compounds with its corresponding trigger, in particular simultaneously using in applications the pro-perfume compounds along with its trigger, as well as an improved fragrance experience for the consumer, in particular providing a long-lasting effect or defined releasing moment of the perfuming ingredients on an article, such as fabrics or clothes.

### DESCRIPTION OF THE INVENTION

The present invention relates to a perfumed consumer product comprising a pro-perfume compound and a trigger, wherein the pro-perfume compound and the trigger are physically separated from each other by comprising
a) the pro-perfume compound or the trigger in a particle;
b) the pro-perfume compound and the trigger in different particles; or
c) the pro-perfume compound and the trigger in different compartments.

According to the present invention, the perfumed consumer product comprises a pro-perfume compound.

Pro-perfume compounds are known to a skilled person and provide a release of a perfuming ingredient, in particular an olfactive perfuming ingredient, upon trigger with an external stimulus, such as upon contact with moisture and/or oxidative agent and/or an activating agent, such as an enzyme, and provide a certain control of the kinetics of fragrance release to induce sensory effects through sequential release.

According to any embodiment, the pro-perfume compound according to the present invention is a pro-fragrance:
obtained by a Michael-type addition and releasing an odoriferous α,β-unsaturated ketone, aldehyde or carboxylic ester, such as but not limited to the one reported in WO200304966, EP1460994, WO2013139766, U.S. Pat. No. 9,758,749, EP10904541, EP2074154, U.S. Pat. Nos. 9,765,282, 9,902,920, WO2016131694, WO200002991, WO200146373, WO2019243369, WO2014202591, WO2008154765, WO2019166314, EP0971021, WO200002991; the content with regard to pro-fragrance compounds of each aforementioned document is incorporated herein by reference;
comprising an imine functional group and being a moisture-labile compound, such as but not limited to the one reported in WO2018134410, EP3192566; the content with regard to pro-fragrance compounds of each aforementioned document is incorporated herein by reference;
comprising a cinnamyl ether functional group and being an oxygen-labile compound, such as but not limited to the one reported in U.S. Pat. No. 9,718,752, US20180016521; the content with regards to pro-fragrance compounds of each aforementioned document is incorporated herein by reference;
comprising enol-ether functional group and being an oxygen-labile compound; such as but not limited to the one reported in WO2019243501, WO2020127708, the content with regards to pro-fragrance compounds of each aforementioned document is incorporated herein by reference;
comprising an alpha-ketoester functional group and being a photo-labile compound, such as but not limited to the one reported in EP1082287, EP2748208; the content with regards to pro-fragrance compounds of each aforementioned document is incorporated herein by reference,
comprising one or two ester functional groups and being an enzymatic-labile compound, such as but not limited to the one reported in WO199504809, EP1061125, WO2019059375, WO2018135647, EP0887335, EP0816322; the content with regards to pro-fragrance compounds of the aforementioned document is incorporated herein by reference,
comprising α,β6-unsaturated ester and being a light-labile compound, such as but not limited to the one reported in EP0936211; the content with regard to pro-fragrance compounds of the aforementioned document is incorporated herein by reference;
comprising a Knoevenagel adduct and being a moisture-labile compound, such as but not limited to the one reported in WO2006076821, WO2007143873, WO2016074699, WO2016091894, WO2018096176; the content with regards to pro-fragrance compounds of each aforementioned document is incorporated herein by reference;
comprising azadioxabicyclooctanes and being moisture-labile compound, such as but not limited to those reported in WO2007087977, WO2010105874; the content with regards to pro-fragrance compounds of each aforementioned document is incorporated herein by reference;
comprising siloxanes and being moisture-labile compounds, such as but not limited to those reported in WO2000014091; the content with regard to pro-fragrance compounds of the aforementioned document is incorporated herein by reference.

When pro-fragrance obtained by a Michael-type addition is used, the perfumed consumer product may also comprise zinc ricinoleate, laureth-3, tetrahydroxypropyl ethylnediamine, propylene glycol or a mixture thereof.

In a particular embodiment, the pro-perfume compound is an enzyme cleavable pro-perfume compound, preferably a lipase-cleavable pro-perfume compound. Hereby, it is understood that the pro-perfume compound is cleavable with an enzyme, preferably a lipase.

In a particular embodiment, the pro-perfume compound is a pro-perfume compound with an ester moiety. Hereby, it is understood that the pro-perfume compound having an ester moiety releases a perfuming ingredient, in particular an olfactive perfuming ingredient, when the ester moiety is cleaved, preferably hydrolyzed, such as a perfuming alcohol and/or perfuming aldehyde or ketone and/or perfuming acid or ester.

In a particular embodiment, the pro-perfume compound is a compound of formula

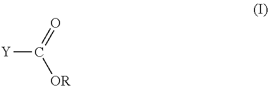

wherein

a.) R represents a monovalent radical derived from a fragrant alcohol of formula ROH and Y represents a C₇ to C₂₄ linear or branched, saturated or unsaturated hydrocarbon radical, or a —(CH₂)ₙCOOR group wherein R is defined as above and n is an integer from 0 to 6; or

b.) Y represents a C₇ to C₂₄ linear or branched, saturated or unsaturated hydrocarbon radical and R represents a group of formula

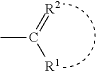

wherein, either R¹ represents hydrogen and R² represents an alkylidene radical derived from a fragrant aldehyde of formula

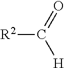

or R¹ and R² are derived from a fragrant ketone of formula

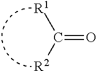

and, taken separately, represent respectively an alkyl radical and an alkylidene radical, or, taken together with their terminal C atoms, represent a substituted or unsubstituted cyclic alkyl, alkenyl, aryl or alkylaryl moiety having 5 to 18 carbon atoms in the ring, such as indicated by the dotted line.

According to any above embodiment, R represents a C₁₋₁₅ alkyl, C₂₋₁₅ alkenyl, C₆₋₁₀ aryl, C₃₋₁₅ cycloalkyl, C₅₋₁₅ cycloalkenyl, C₄₋₁₄ heterocycloalkyl or C₄₋₁₄ heterocycloalkenyl group, each optionally substituted with one or more a C₁₋₁₅ alkyl, C₂₋₁₅ alkenyl, C₁₋₁₅ alkoxy, C₃₋₁₅ cycloalkyl, C₅₋₁₅ cycloalkenyl, C₆₋₁₀ aryl and/or C₆₋₁₀ aryloxy group, each optionally substituted with one or more of a C₁₋₈ alkyl, C₁₋₈ alkoxy, oxo, carboxylic acid and/or C₁₋₄ carboxylic ester group

The terms “alkyl” and “alkenyl” are understood as comprising branched and linear alkyl and alkenyl groups. The terms “alkenyl”, “cycloalkenyl” and “heterocycloalkenyl” are understood as comprising 1, 2 or 3 olefinic double bonds, preferably 1 or 2 olefinic double bonds. The terms “cycloalkyl”, “cycloalkenyl”, “heterocycloalkyl” and “heterocycloalkenyl” are understood as comprising a monocyclic or fused, spiro and/or bridged bicyclic or tricyclic cycloalkyl, cycloalkenyl, heterocycloalkyl and heterocycloalkenyl groups, preferably monocyclic cycloalkyl, cycloalkenyl, heterocycloalkyl and heterocycloalkenyl groups.

The term “aryl” is understood as comprising any group comprising at least one aromatic group such as phenyl, indenyl, indanyl, tetrahydronaphthalenyl or naphthalenyl group.

It is impossible to list in an exhaustive manner all the alcohols of formula ROH for the pro-perfume compound of formula (I) known to this day, which are capable of imparting pleasant odours for example to the textiles treated with the laundry products perfumed by way of said alcohols, and the perfuming effect of which can be remarkably improved according to the invention. However, by way of example, one can cite alcohols such as anisic alcohol, cinnamic alcohol, fenchylic alcohol, 9-decen-1-ol, phenyl ethyl alcohol, phenylmethanol, citronellol (3,7-dimethyloct-6-en-1-ol), 4-methyl-3-decen-5-ol, cis-3-hexenol, trans-2-hexenol, 2-isopropenyl-5-methyl-4-hexenol, 3-methyl-5-phenyl-1-pentanol (origin: Firmenich SA, Geneva, Switzerland), 4-methyl-6-phenyl-2-hexanol, Mayol® (7-p-menthan-1-ol; origin: Firmenich SA, Geneva, Switzerland), dihydromyrcenol (2,6-dimethyl-7-octen-2-ol), geraniol or nerol (3,7-dimethyl-2,6-octadien-1-ol), 3,7-dimethyl-1-octanol, 2-methyl-3-(4-methylphenyl)-2-propen-1-ol, 2,5-dimethyl-2-indanmethanol, 1-hexanol, 2-hexanol, 2-ethylhexanol, (1'S,3′R)-{1-methyl-2-[(1′,2′,2′-trimethylbicyclo[3.1.0]hex-3′-yl)methyl]cyclopropyl}methanol, a/pha-santalol, beta-santalol, 1-[2,2,3,6-tetramethylcyclohexyl]-3-hexanol, patchoulol, 3,3-dimethyl-5-[2,2,3-trimethyl-3-cyclopenten-1-yl]-4-penten-2-ol, 5-ethyl-2-nonanol, 2,6-nonadien-1-ol, borneol, 1-octen-3-ol, 4-cyclohexyl-2-methyl-2-butanol (origin: Firmenich SA, Geneva, Switzerland), 2-methyl-4-phenyl-2-butanol, 2-methyl-1-phenyl-2-propanol, 3-phenyl-1-propanol, menthol, 2-phenylethanol, cyclomethylcitronellol, decanol, dihydroeugenol, 8-p-menthanol, 3,7-dimethyl-1-octanol, 3,7-dimethyl-3-octanol, 2,6-dimethyl-2-heptanol,2,6-dimethyl-2-octanol, dodecanol, eugenol, 4-hydroxy-3-methoxybenzaldehyde, 3-ethoxy-4-hydroxybenzaldehyde, 4-(4-hydroxyphenyl)-2-butanone,2-ethyl-4-(2,2,3-trimethyl-3-cyclopenten-1-yl)-2-buten-1-ol, 3,6,8,8-tetramethyloctahydro-1H-3a,7-methanoazulen-6-ol, 4-cyclohexyl-2-methyl-2-butanol, 2-ethyl-4-[(1R)-2,2,3-trimethyl-3-cyclopenten-1-yl]-2-buten-1-ol, 3,4-dimethylphenol, 3,7-dimethyl-1,6-nonadien-3-ol, 2-methyl-4-[(1R)-2,2,3-trimethyl-3-cyclopenten-1-yl]-4-penten-1-ol, (1R,3R,4S)-8-p-menthen-3-ol, 3,3-dimethyl-5-[(2,2,3-trimethyl-3-cyclopenten-1-yl]-4-penten-2-ol, 1-[2,2,6-trimethylcyclohexyl]-3-hexanol, 2,2,6,8-tetramethyl-1,2,3,4,4a,5,8,8a-octahydro-1-naphthalenol, 4,8-dimethyl-2,7-nonadien-4-ol, 3-propylphenol, Florol® (tetrahydro-2-isobutyl-4-methyl-4(2H)-pyranol; origin: Firmenich SA, Geneva, Switzerland), isoeugenol, linalol, dihydrolinalol, Tarragol® (2-methoxy-4-propyl-1-cylohexanol; origin: Firmenich SA, Geneva, Switzerland), terpineol, dihydroterpineol, tetrahydromuguol, 3,7-dimethyl-3-octanol and Lyral® (3 and 4-(4-hydroxy-4-methylpentyl)-cyclohex-3-ene-1-carbaldehyde: origin: International Flavors and Fragrances, USA). Preferably, the alcohols of formula ROH for the pro-perfume compound of formula (I) may be selected from the group including phenyl ethyl alcohol, citronellol, 9-decen-1-ol, 2,6-nonadien-1-ol and geraniol.

It is quite obvious, however, that the pro-perfume compound of formula (I) is general and can relate to many other alcohols which the skilled person is quite able to choose from the general knowledge in the art and as a function of the olfactive effect it desires to achieve.

Analogous considerations apply to the aldehydes of formula

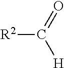

and to the ketones of formula

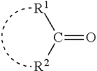

The pro-perfume compound of formula (I) is particular advantageous whenever the compounds such as those mentioned above show a weak tenacity on fabrics, and there are many odoriferous aldehydes and ketones whose performance on textiles turns out to be distinctly improved when these compounds exert their perfuming activity by way of the corresponding enol-esters of formula (I).

Again, although it is impossible to list in an exhaustive manner all the fragrant aldehydes and ketones which are capable of providing beneficial effects, such as an perfuming effect, there can be cited, by way of example, compounds such as C6 to C12 aldehydes, hydratropic aldehyde, methyl nonyl acetaldehyde, phenylpropanoic aldehyde, Acropal®. [3- or 4-(4-methyl-3-pentenyl)-3-cyclohexene-1-carbaldehyde; origin: Givaudan-Roure, Vernier, Switzerland], 2-methyldecanal, 4-isopropyl-1-benzeneacetaldehyde, (4-methyl-1-phenyl)acetaldehyde, Z-6-nonenal, citral, citronellal, 9-decenal, 3-(4-isopropylphenyl)-2-methylpropanal (origin: Firmenich SA, Geneva, Switzerland), (E,E)-2,4-heptadienal, (E,E)-2,4-nonadienal, (E,E)-2,4-decadienal, 5,9-dimethyl-4,9-decadienal, (Z)-6-octenal, Farenal® (2,6,10-trimethyl-9-undecenal; origin: Givaudan-Roure, Vernier, Switzerland), Foliaver® [3-(4-methoxy-1-phenyl)-2-methylpropanal; origin: International Flavors and Fragrances, USA], Heliopropanal® [3-(1,3-benzodioxol-5-yl)-2-methylpropanal; origin: International Flavors and Fragrances, USA], (Z)-4-heptenal, le 3,5,5-trimethylhexanal (origin: International Flavors and Fragrances, USA), (4-methyl-1-phenoxy)acetaldehyde, hydroxycitronellal, isocyclocitral (origin: International Flavors and Fragrances, USA), Lilial® [3-(4-tert-butyl-1-phenyl)-2-methylpropanal; origin: Givaudan-Roure, Vernier, Switzerland], le 1-p-menthene-9-carbaldehyde (origin: Firmenich SA, Geneva, Switzerland), Lyral® [3- and 4-(4-hydroxy-4-methylpentyl)-3-cyclohexene-1-carbaldehyde; origin: International Flavors and Fragrances, USA], 2,6-dimethyl-5-heptenal, 1-p-menthen-9-al, (E)-2-octenal, (2E,6Z)-2,6-nonadienal, 3-methyl-5-phenylpentanal, (E)-4-decenal, (E)-2-undecenal, 3,7-dimethyloctanal, Zestover (2,4-dimethyl-3-cyclohexene-1-carbaldehyde; origin: Firmenich SA, Geneva, Switzerland), 3-phenylbutanal, Scentenal® (octahydro-5-methoxy-4,7-methano-1H-indene-2-carboxaldehyde; origin: Firmenich SA, Geneva, Switzerland), 2,5,9-trimethyl-4,9-decadienal, Intreleven aldehyde (undecenal; origin: International Flavors and Fragrances, USA), 4-methyl-phenyl-propanoic aldehyde, 4-(4-hydroxy-1-phenyl)-2-butanone, benzylacetone, the ionones, 3-(4-tert-butyl-1-phenyl)propanal, carvone, 3,7-dimethyl-1,1-bis(11-methyldodecyloxy)-2,6-octadiene, muscone, 2-pentyl-1-cyclopentanone, ethyl amyl ketone, ethyl pentyl ketone, la 2-heptyl-1-cyclopentanone, geranylacetone, Iralia® (methylionone; origin: Firmenich SA, Geneva, Switzerland), Iso E super [1-(octahydro-2,3,8,8-tetramethyl-2-naphtalenyl)-1-ethanone; origin: International Flavors and Fragrances, USA], 6-methyl-5-hepten-2-one, methyl jasmonate, methyl hexyl ketone, methyl pentyl ketone, methylnonyl ketone, cis-jasmone, Hedione® (methyl dihydrojasmonate; origin: Firmenich SA, Geneva, Switzerland), civettone, 4-(1,1-dimethylpropyl)-1-cyclohexanone, Exaltone® (cyclopentadecanone; origin: Firmenich SA, Geneva, Switzerland), 2,6,6-trimethyl-2-cyclohexene-1,4-dione, p-tert-butylcyclohexanone, tricyclo[6.2.1.0^{2,7}]undec-9-en-3-one (origin: Firmenich SA, Geneva, Switzerland), 10,10-dimethyltricyclo[7.1.10^{2,7}]undec-2-en-4-one (origin: Firmenich SA, Geneva, Switzerland), Vertofix coeur (origin: International Flavors and Fragrances, USA), 1a perhydro-5,5,8a-trimethyl-2-naphtalenone (origin: Firmenich SA, Geneva, Switzerland) or 5-methyl-exo-tricyclo[6.2.1.0^{2,7}]undecan-4-one.

In a particular embodiment, in the pro-perfume compound of formula (I), Y represents a —(CH₂)ₙCOOR group, R standing for a monovalent radical derived from a fragrant alcohol of formula ROH and n being an integer from 0 to 6.

In a particular embodiment, in the pro-perfume compound of formula (I), Y represents a C₇ to C₂₄ linear or branched, saturated or unsaturated hydrocarbon radical.

In a particular embodiment, in the pro-perfume compound of formula (I), Y is a C₁₂ to C₂₄ linear or branched, saturated or unsaturated hydrocarbon radical.

In a particular embodiment, the pro-perfume compound of formula (I) is (2E)-3,7-dimethyl-2,6-octadienylhexadecanoate, 2-phenylethyl palmitate, 2-phenylethyl (2-phenylethyl) succinate, 3-hexen-1-yl palmitate, 3-hexen-1-yl (3-hexen-1-yl) succinate, 9-decenyl palmitate, 9-decenyl (9-decenyl) succinate, 3,7-dimethylocta-2,6-dien-1-yl palmitate, 3,7-dimethylocta-2,6-dien-1-yl (3,7-dimethylocta-2,6-dien-1-yl) succinate, nona-2,6-dien-1-yl palmitate, nona-2,6-dien-1-yl (nona-2,6-dien-1-yl) succinate, 3,7-dimethyl-6-octen-1-yl palmitate and 3,7-dimethyl-6-octen-1-yl (3,7-dimethyl-6-octen-1-yl) succinate.

According to any above embodiment, the pro-perfume compound according to the present invention can be one of the following pro-perfume or pro-fragrance compounds:
comprising an ester functional group, such as the pro-perfume compounds mentioned in WO2018135647; the content with regard to pro-perfume or pro-fragrance compounds of the aforementioned document is incorporated herein by reference,
comprising an ester or enol-ester functional group, such as the pro-perfume compounds mentioned in EP 0 887 335 or WO 98/58899; the content with regard to pro-perfume or pro-fragrance compounds of the aforementioned documents is incorporated herein by reference.

The perfumed consumer product can comprise 1 to 5 pro-perfume compounds, more preferably 1 to 3 pro-perfume compounds. Thereby, it is understood that the perfumed consumer product comprises 1 to 5 structurally different pro-perfume compounds, more preferably 1 to 3 structurally different pro-perfume compounds.

In a particular embodiment, the amount of pro-perfume compounds is in the range of 0.0001 to 20% by weight, preferably 0.001 to 17% by weight, more preferably 0.01 to 15% by weight and most preferably 0.05 to 10% by weight, based on the total weight of the perfumed consumer product.

According to the present invention, the perfumed consumer product comprises a trigger.

Triggers or trigger agents for pro-perfume compounds are known to a skilled person and are herein understood as an external stimulus which are able to provide release of a perfuming ingredient, in particular an olfactive perfuming ingredient from a pro-perfume compound, such as moisture and/or oxidative agents and/or activating agent, such as enzymes.

The trigger may be an agent which is able to cleave an ester in an alcohol and an acid, aldehyde or ketone or esters, such as acids, bases, enzymes etc.

In a particular embodiment, the trigger is an enzyme, preferably a lipase.

In a particular embodiment, the amount of trigger, preferably the lipase, is in the range of 0.0001 to 1% by weight, preferably 0.001 to 0.9% by weight, more preferably 0.005 to 0.7% by weight and most preferably 0.01 to 0.5% by weight, based on the total weight of the perfumed consumer product.

According to the present invention, the pro-perfume compound and the trigger are physically separated from each other by comprising
a) the pro-perfume compound or the trigger in a particle;
b) the pro-perfume compound and the trigger in different particles; or
c) the pro-perfume compound and the trigger in different compartments.

Thereby, it is understood that the pro-perfume compound and the trigger are comprised in different compartments or different particles or only one is comprised in a particle within the perfumed consumer product. Thereby, it is also understood that the pro-perfume compound and the trigger are physically separated from each other in the perfumed consumer product and only get in contact with each other during use of the product or after use.

The particle may be in the form of a granule or in the form of a microcapsule. “Granule” defined in the present invention refers to a delivery system comprising a hydrophobic active ingredient dispersed in a matrix or a carrier. By contrast, “microcapsule” or “core-shell microcapsule” refers to a delivery system comprising an oil-based core of a hydrophobic active ingredient encapsulated by a polymeric shell.

By hydrophobic active ingredient, it is meant to designate any hydrophobic compound such as the pro-perfume compound or the trigger.

The nature of the polymeric shell from the microcapsules of the invention can vary.

As non-limiting examples, the shell can be aminoplast-based, polyurethane-based, polyamide-based, polyester-based or polyurea-based.

According to an embodiment, the shell is a biopolymer-based shell comprising a protein.

The shell can also be hybrid, namely organic-inorganic such as a hybrid shell composed of at least two types of inorganic particles that are cross-linked, or yet a shell resulting from the hydrolysis and condensation reaction of a polyalkoxysilane macro-monomeric composition.

According to an embodiment, the shell comprises an aminoplast copolymer, such as melamine-formaldehyde or urea-formaldehyde or cross-linked melamine formaldehyde or melamine glyoxal.

According to another embodiment, the microcapsules have a polymeric shell resulting from complex coacervation wherein the shell is possibly cross-linked.

According to another embodiment, the shell is polyurea-based made from, for example but not limited to isocyanate-based monomers and amine-containing crosslinkers such as guanidine carbonate and/or guanazole. Preferred polyurea microcapsules comprise a polyurea wall which is the reaction product of the polymerisation between at least one polyisocyanate comprising at least two isocyanate functional groups and at least one reactant selected from the group consisting of an amine (for example a water-soluble guanidine salt and guanidine); a colloidal stabilizer or emulsifier; and an encapsulated the pro-perfume compound or the trigger. However, the use of an amine can be omitted.

According to a particular embodiment, the colloidal stabilizer includes an aqueous solution of between 0.1% and 0.4% of polyvinyl alcohol, between 0.6% and 1% of a cationic copolymer of vinylpyrrolidone and of a quaternized vinylimidazol (all percentages being defined by weight relative to the total weight of the colloidal stabilizer). According to another embodiment, the emulsifier is an anionic or amphiphilic biopolymer preferably chosen from the group consisting of gum Arabic, soy protein, gelatin, sodium caseinate and mixtures thereof.

The preparation of an aqueous dispersion/slurry of core-shell microcapsules is well known by a skilled person in the art. In one aspect, said microcapsule wall material may comprise any suitable resin and especially including melamine, glyoxal, polyurea, polyurethane, polyamide, polyester, etc. Suitable resins include the reaction product of an aldehyde and an amine, suitable aldehydes include, formaldehyde and glyoxal. Suitable amines include melamine, urea, benzoguanamine, glycoluril, and mixtures thereof. Suitable melamines include, methylol melamine, methylated methylol melamine, imino melamine and mixtures thereof. Suitable ureas include dimethylol urea, methylated dimethylol urea, urea-resorcinol, and mixtures thereof. Suitable materials for making may be obtained from one or more of the following companies Solutia Inc. (St Louis, Mo. U.S.A.), Cytec Industries (West Paterson, N.J. U.S.A.), Sigma-Aldrich (St. Louis, Mo. U.S.A.).

According to a particular embodiment, the core-shell microcapsule is a formaldehyde-free capsule. A typical process for the preparation of aminoplast formaldehyde-free microcapsules slurry comprises the steps of

1) preparing an oligomeric composition comprising the reaction product of, or obtainable by reacting together
a) a polyamine component in the form of melamine or of a mixture of melamine and at least one C₁-C₄ compound comprising two NH₂ functional groups;
b) an aldehyde component in the form of a mixture of glyoxal, a C₄₋₆ 2,2-dialkoxy-ethanal and optionally a glyoxalate, said mixture having a molar ratio glyoxal/C₄₋₆ 2,2-dialkoxy-ethanal comprised between 1/1 and 10/1; and
c) a protic acid catalyst;

2) preparing an oil-in-water dispersion, wherein the droplet size is comprised between 1 and 600 um, and comprising:
i. an oil;
ii. a water medium
iii. at least an oligomeric composition as obtained in step 1;
iv. at least a cross-linker selected amongst
A) C₄-C₁₂ aromatic or aliphatic di- or tri-isocyanates and their biurets, triurets, trimmers, trimethylol propane-adduct and mixtures thereof; and/or
B) a di- or tri-oxiran compounds of formula

A-(oxiran-2-ylmethyl)ₙ
wherein n stands for 2 or 3 and 1 represents a C₂-C₆ group optionally comprising from 2 to 6 nitrogen and/or oxygen atoms;
   v. optionally a C₁-C₄ compounds comprising two NH₂ functional groups;

3) Heating said dispersion;

4) Cooling said dispersion.

This process is described in more details in WO 2013/068255, the content of which is included by reference.

According to another embodiment, the shell of the microcapsule is polyurea- or polyurethane-based.

Examples of processes for the preparation of polyurea and polyureathane-based microcapsule slurry are for instance described in WO2007/004166, EP 2300146, EP2579976 the contents of which is also included by reference. Typically, a process for the preparation of polyurea or polyurethane-based microcapsule slurry include the following steps:
a) Dissolving at least one polyisocyanate having at least two isocyanate groups in an oil to form an oil phase;
b) Preparing an aqueous solution of an emulsifier or colloidal stabilizer to form a water phase;
c) Adding the oil phase to the water phase to form an oil-in-water dispersion, wherein the mean droplet size is comprised between 1 and 500 μm, preferably between 5 and 50 μm;
d) Applying conditions sufficient to induce interfacial polymerisation and form microcapsules in form of a slurry.

In a particular embodiment, the particle may be a granule wherein the hydrophobic ingredient; i.e. the pro-perfume compound or the trigger, is dispersed or adsorbed in a matrix or carrier being a water-soluble material.

According to any embodiment, the water-soluble matrix or carrier is a monomeric, oligomeric or polymeric carrier material, or mixtures of two or more of these. An oligomeric carrier is a carrier wherein 2-10 monomeric units are linked by covalent bonds. For example, if the oligomeric carrier is a carbohydrate, the oligomeric carrier may be sucrose, lactose, raffinose, maltose, trehalose, fructo-oligosaccharides.

Examples of a monomeric carrier materials are glucose, fructose, mannose, galactose, arabinose, fucose, sorbitol, mannitol, for example.

Polymeric carriers have more than 10 monomeric units that are linked by covalent bonds.

The carrier may be a polymeric carrier material. Non-limiting examples of polymeric carrier material includes urea, polyvinyl acetates, polyvinyl alcohol, dextrines, maltodextrines, glucose syrups, natural or modified starch, polysaccharides, carbohydrates, chitosan, gum Arabic, polyethylene glycol (PEG), polyvinyl pyrrolidone, polyvinyl alcohol, acrylamides, acrylates, methacrylate, polyacrylic acid and related, maleic anhydride copolymers, amine-functional polymers, polyvinyl benzyl chloride, vinyl ethers, styrenes, polystyrenesulfonates, vinyl acids, ethylene glycol-propylene glycol block copolymers, vegetable gums, gum acacia, pectins, xanthanes, alginates, carragenans, cellulose or cellulose derivatives, such as carboxymethyl methylcellulose, methylcellulose, ethylcellulose, propylcellulose or hydroxyethyl cellulose, polyols/sugar alcohols such as sorbitol, maltitol, xylitol, erythritol, and isomalt, PVP, citric acid or any water soluble solid acid, fatty alcohols or fatty acids and mixtures thereof.

According to a particular embodiment, the water-soluble polymer comprises Maltodextrin having a Dextrose Equivalent (DE) comprised between 3 and 20, preferably between 10 and 18.

According to an embodiment, the water-soluble polymer comprises Maltodextrin 18DE and/or Maltodextrin 10DE.

According to a particular embodiment, the water-soluble polymer comprises Maltodextrin 10DE.

According to an embodiment, carrier is an inorganic material chosen in the group consisting of sodium chloride, sodium sulphate, sodium acetate, zeolite, sodium carbonate, sodium bicarbonate, clay, talc, calcium carbonate, magnesium sulfate, gypsum, calcium sulfate, magnesium oxide, zinc oxide, titanium dioxide, calcium chloride, potassium chloride, magnesium chloride, zinc chloride.

According to a particular embodiment, the solid carrier is sodium chloride and/or urea.

According to a particular embodiment, the solid carrier is sodium chloride.

According to a particular embodiment, the solid carrier is a mixture of clay and PEG, preferably the mixture comprises 0-30% clay and 20-80% PEG, preferably between 1-30% clay and 20-80% PEG, based to the total weight of the carrier.

According to a particular embodiment, the solid carrier is a mixture of sodium acetate and PEG, preferably the mixture comprises 0-80% sodium acetate and 0-50% PEG, preferably 1-80% sodium acetate and 1-50% PEG.

PEG has preferably a molecular weight greater than 1000 g/mol, preferably between 1000 and 8000 g/mol.

According to a particular embodiment, the pro-perfume compound is comprised in a granule or in a core-shell microcapsule and the trigger is not part of a particle.

According to a particular embodiment, the trigger compound is comprised in a granule or in a core-shell microcapsule and the pro-perfume compound is not part of a particle.

According to a particular embodiment, the pro-perfume compound and the trigger are comprised in different core-shell microcapsule or the pro-perfume compound and the trigger are comprised in different granules and at least one of the granules comprises a water-soluble carrier material, preferably both granules are surrounded by a water-soluble carrier material.

It is herein also understood that the pro-perfume compound can be dispersed in or adsorbed within a granule and optionally the trigger can be either dispersed in or adsorbed within a different granule or can be comprised in a different particle in form of a microcapsule, such as a core-shell microcapsule, or that the pro-perfume compound can be comprised in a particle in form of a microcapsule, such as a core-shell microcapsule, and the trigger can be either dispersed in or adsorbed within a different particle or can be comprised in a different particle in form of a microcapsule, such as a core-shell microcapsule.

According to any embodiment, a particle according to the present invention has a median volume-weighted particle size from 5 to 2000 μm, preferably 6 to 800 μm and more preferably 10 to 500 μm. The median volume-weighted particle size of particles can be measured by a particle size analyzer (Malvern).

In a particular embodiment of the present invention, the pro-perfume compound and the trigger are comprised in different compartments.

Thereby it is understood, that the perfumed consumer product is designed in a manner to comprise different compartments and to hold in one compartment the pro-perfume compound and in a different compartment the trigger. By compartment, it is herein understood that the compartment is a closed internal space.

The perfumed consumer product may comprise more than two compartments or even at least three compartments. The compartments may be arranged in superposed orientation, i.e. on positions on top of each other. Alternatively, the compartments may be positioned in a side-by-side orientation, i.e. one orientated next to each other. The compartments can also be orientated in a “tire-and-rim”-arrangement, i.e. a first compartment is positioned next to a second compartment, and the first compartment at least partially surrounds the second compartment, not completely enclosed the second compartment. Alternatively, one compartment may be completely enclosed within another compartment.

One of the compartments can be smaller than the other compartment. When the perfumed consumer product comprises at least three compartments, two of the compartments may be smaller than the third compartment and preferably the smaller compartments are superposed on the larger compartment. The superposed compartments preferably are orientated side-by side.

In a particular embodiment, the pro-perfume compound and the trigger are in different compartments and at least one of the compartments is surrounded by a water-soluble barrier material, preferably both compartments are surrounded by a water-soluble barrier material.

In a particular embodiment, the water-soluble barrier material of the compartment(s) comprises polyvinyl alcohols (PVA), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum, polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, preferably polyvinylalcohols.

In an alternative embodiment, the pro-perfume compound and the trigger are in different compartments and at least one of the compartments is surrounded by a barrier material which is not water soluble, preferably both compartments are surrounded by a barrier material which is not water soluble.

In a particular embodiment, the barrier material which is not what is suitable is made from the material being selected from high density polyethylene (HDPE), polypropylene (PP) or polyethylene terephthalate (PET) or combinations thereof.

In a particular embodiment, in case the compartments are surrounded by a barrier material which is not water-soluble, the compartments are comprised within pouring means, such as a bottle.

The perfumed consumer product can further comprise a perfume.

By “perfume” (or also “perfume oil”) what is meant here is an ingredient or composition that is a liquid at about 20° C. According to any one of the above embodiments said perfume oil can be a perfuming ingredient alone or a mixture of ingredients in the form of a perfuming composition. As a “perfuming ingredient” or “fragrance ingredient” it is meant here a compound, which is used for the primary purpose of conferring or modulating an odour. In other words, such an ingredient, to be considered as being a perfuming one, must be recognized by a person skilled in the art as being able to at least impart or modify in a positive or pleasant way the odor of a composition, and not just as having an odor.

The nature and type of the perfuming ingredients present in the base do not warrant a more detailed description here, which in any case would not be exhaustive, the skilled person being able to select them on the basis of his general knowledge and according to the intended use or application and the desired organoleptic effect. In general terms, these perfuming ingredients belong to chemical classes as varied as alcohols, lactones, aldehydes, ketones, esters, ethers, acetates, nitriles, terpenoids, nitrogenous or sulphurous heterocyclic compounds and essential oils, and said perfuming ingredients can be of natural or synthetic origin.

In particular, one may cite perfuming ingredients knows for having a similar olfactive note, such as:

In particular, one may cite perfuming ingredients which are commonly used in perfume formulations, such as:
Aldehydic ingredients: decanal, dodecanal, 2-methyl-undecanal, 10-undecenal, octanal and/or nonenal;
Aromatic-herbal ingredients: eucalyptus oil, camphor, eucalyptol, menthol and/or alpha-pinene;
Balsamic ingredients: coumarine, ethylvanillin and/or vanillin;
Citrus ingredients: dihydromyrcenol, citral, orange oil, linalyl acetate, citronellyl nitrile, orange terpenes, limonene, 1-P-menthen-8-yl acetate and/or 1,4(8)-P-menthadiene;
Floral ingredients: Methyl dihydrojasmonate, linalool, citronellol, phenylethanol, 3-(4-tert-butylphenyl)-2-methylpropanal, hexylcinnamic aldehyde, benzyl acetate, benzyl salicylate, tetrahydro-2-isobutyl-4-methyl-4(2H)-pyranol, beta ionone, methyl 2-(methylamino)benzoate, (E)-3-methyl-4-(2,6,6-trimethyl-2-cyclohexen-1-yl)-3-buten-2-one, hexyl salicylate, 3,7-dimethyl-1,6-nonadien-3-ol, 3-(4-isopropylphenyl)-2-methylpropanal, verdyl acetate, geraniol, P-menth-1-en-8-ol, 4-(1,1-dimethylethyl)-1-cyclohexyle acetate, 1,1-dimethyl-2-phenylethyl acetate, 4-cyclohexyl-2-methyl-2-butanol, amyl salicylate, high cis methyl dihydrojasmonate, 3-methyl-5-phenyl-1-pentanol, verdyl proprionate, geranyl acetate, tetrahydro linalool, cis-7-P-menthanol, Propyl (S)-2-(1,1-dimethylpropoxy)propanoate, 2-methoxynaphthalene, 2,2,2-trichloro-1-phenylethyl acetate, 4/3-(4-hydroxy-4-methylpentyl)-3-cyclohexene-1-carbaldehyde, amylcinnamic aldehyde, 4-phenyl-2-butanone, isononyle acetate, 4-(1,1-diméthyléthyl)-1-cyclohexyl acetate, verdyl isobutyrate and/or mixture of methylionones isomers;
Fruity ingredients: gamma undecalactone, 4-decanolide, ethyl 2-methyl-pentanoate, hexyl acetate, ethyl 2-methylbutanoate, gamma nonalactone, allyl heptanoate, 2-phenoxyethyl isobutyrate, ethyl 2-methyl-1,3-dioxolane-2-acetate and/or diethyl 1,4-cyclohexane dicarboxylate;
Green ingredients: 2,4-dimethyl-3-cyclohexene-1-carbaldehyde, 2-tert-butyl-1-cyclohexyl acetate, styrallyl acetate, allyl (2-methylbutoxy)acetate, 4-methyl-3-decen-5-ol, diphenyl ether, (Z)-3-hexen-1-ol and/or 1-(5,5-dimethyl-1-cyclohexen-1-yl)-4-penten-1-one;
Musk ingredients: 1,4-dioxa-5,17-cycloheptadecanedione, pentadecenolide, 3-methyl-5-cyclopentadecen-1-one, 1,3,4,6,7,8-hexahydro-4,6,6,7,8,8-hexamethyl-cyclopenta-g-2-benzopyrane, (1S,1′R)-2-[1-(3′,3′-dimethyl-1′-cyclohexyl)ethoxy]-2-methylpropyl propanoate, pentadecanolide and/or (1S,1′R)-[1-(3′,3′-Dimethyl-1′-cyclohexyl)ethoxycarbonyl]methyl propanoate;
Woody ingredients: 1-(octahydro-2,3,8,8-tetramethyl-2-naphtalenyl)-1-ethanone, patchouli oil, terpenes fractions of patchouli oil, (1′R,E)-2-ethyl-4-(2′,2′,3′-trimethyl-3′-cyclopenten-1′-yl)-2-buten-1-ol, 2-ethyl-4-(2,2,3-trimethyl-3-cyclopenten-1-yl)-2-buten-1-ol, Methyl cedryl ketone, 5-(2,2,3-trimethyl-3-cyclopentenyl)-3-methylpentan-2-ol, 1-(2,3,8,8-tetramethyl-1,2,3,4,6,7,8,8a-octahydronaphthalen-2-yl)ethan-1-one and/or isobornyl acetate;
Other ingredients (e.g. amber, powdery spicy or watery): dodecahydro-3a,6,6,9a-tetramethyl-naphtho[2,1-b]furan and any of its stereoisomers, heliotropin, anisic aldehyde, eugenol, cinnamic aldehyde, clove oil, 3-(1,3-benzodioxol-5-yl)-2-methylpropanal and/or 3-(3-isopropyl-1-phenyl)butanal.

A perfume according to the invention may not be limited to the above mentioned perfuming ingredients, and many other of these co-ingredients are in any case listed in reference texts such as the book by S. Arctander, Perfume and Flavor Chemicals, 1969, Montclair, N.J., USA, or its more recent versions, or in other works of a similar nature, as well as in the abundant patent literature in the field of perfumery. It is also understood that said co-ingredients may also be compounds known to release in a controlled manner various types of perfuming compounds.

The perfuming ingredients may be dissolved in a solvent of current use in the perfume industry. The solvent is preferably not an alcohol. Examples of such solvents are diethyl phthalate, isopropyl myristate, Abalyn® (rosin resins, available from Eastman), benzyl benzoate, ethyl citrate, limonene or other terpenes, or isoparaffins. Preferably, the solvent is very hydrophobic and highly sterically hindered, like for example Abalyn® or benzyl benzoate. Preferably the perfume comprises less than 30% of solvent. More preferably the perfume comprises less than 20% and even more preferably less than 10% of solvent, all these percentages being defined by weight relative to the total weight of the perfume. Most preferably, the perfume is essentially free of solvent.

According to any one of the above embodiments, the perfume may be partly or totally encapsulated in a core-shell microcapsule or be dispersed or adsorbed on a carrier. The nature of the polymeric shell from the core-shell microcapsules and the nature of the carrier are as defined previously.

The perfume can be in combination with the pro-perfume compound and/or the perfume can be in combination with the trigger. Thereby, it is understood that the perfume comprises the pro-perfume compound and/or the perfume comprises the trigger. Preferably, the perfume can be in combination with the pro-perfume compound. Thereby, it is understood that the perfume comprises a pro-perfume compound.

The perfume, in particular comprising the pro-perfume compound, and/or the perfume, in particular comprising the trigger, can be in any compartment or particle, i.e. the perfume, in particular comprising the pro-perfume compound, can be in one compartment or particle and/or the perfume in particular comprising the trigger, can be in another compartment or particle. Preferably, the perfume is in combination with the pro-perfume compound.

In an alternative embodiment, the perfume is not in combination with both, the pro-perfume compound or the trigger. Thereby, it is understood that the perfume is in a different compartment or particle than the pro-perfume compound and the trigger.

According to any embodiments, the perfumed consumer product may further comprise a detergent or cleaning composition which may be in the form of a liquid, a powder, a compacted powder, or a mixture thereof. By the term ‘liquid’ it is herein understood any composition capable of wetting and treating a substrate. A liquid may also encompass forms such as dispersions, gels, pastes and the like. These liquid compositions could have varying levels of water or could even be water-free. For example, a dispersion may be a liquid which comprises solid or particulate matter.

By “detergent or cleaning composition” such as a “fabric detergent or cleaning composition” it is herein understood compositions that provide cleaning benefit to articles. Such articles may be fabrics, care benefit to fabrics or a mixture thereof. The detergent or cleaning composition in particular a fabric detergent or cleaning composition may provide a cleaning benefit. The cleaning benefit may be stain removal, stain repellency, anti-soil-redeposition, brightening, whitening dirt removal, malodour reduction and/or mixtures thereof. The detergent or cleaning composition in particular the fabric detergent or cleaning composition may provide a care benefit. The care benefit may be softening, freshness, anti-wrinkling, anti-colour fading, dye transfer inhibition, anti-static and/or mixtures thereof.

The detergent or cleaning composition may comprise anionic surfactants, non-ionic surfactants, cationic surfactants, polyethylene glycol polymers, ethoxylated polyethyleneimines, hueing dyes, perfumes, perfume microcapsules, a rheology modifier, chelants, enzymes, silicones, polyolefin waxes, latexes, oily sugar derivatives, cationic polysaccharides, polyurethanes, fatty acids, antioxidants, opacifier, pearlescent agent, enzyme stabilizing systems; deposition aid, builder, bleaching agent, bleach activator, bleach catalyst, organic shine polymers, surface modifying polymers, metal salts, metal care agents, anti-corrosion agents and mixtures thereof.

The detergent or cleaning composition may comprise from about 1% to 80% by weight of the detergent or cleaning composition of a surfactant. The surfactant may comprise or be selected from anionic, nonionic, zwitterionic, ampholytic, zwitterionic, semi-polar, cationic surfactants and/or mixtures thereof. In particular, the surfactant may comprise anionic, nonionic, cationic surfactants and mixtures thereof.

The detergent or cleaning composition may comprise a polymer. The polymer may be polyethylene glycol polymers, carboxylate polymers terephthalate polymers, amine polymers, dye transfer inhibition polymers, cellulosic polymers dye lock polymers such as a condensation oligomer produced by condensation of imidazole and epichlorhydrin, optionally in ratio of 1:4:1, hexamethylenediamine derivative polymers, ethoxylated polyethyleneimines and any combination thereof.

The detergent or cleaning composition may comprise hydroxyethyl cellulose polymer. The cellulose polymer may have a molecular weight of between 100 and 800 kDaltons. In particular, the hydroxyethyl cellulose polymer is derivatised with trimethyl ammonium substituted epoxide. The hydroxyethyl cellulose polymer may be added to the composition in a particulate form. The cellulose polymer may be present in the composition of the particle or may be also be present as a liquid or a mixture thereof.

The detergent or cleaning composition may further comprise an enzyme. The enzyme may be selected from hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, B glucanases, arabinosidases, hyaluronidase, chondroitinase, laccase, and amylases, or mixtures thereof. Preferably, the detergent or cleaning composition comprises lipases as the trigger.

The detergent or cleaning composition may comprise a bleaching agent. Bleaching agents may comprise for example chlorine bleaches, oxygen bleaches, or mixtures thereof. In particular, the bleach may be sodium perborate monohydrate, sodium perborate tetrahydrates, sodium percarbonate, and/or mixtures thereof.

The detergent or cleaning composition may comprise a peroxyacid bleach precursors, preferably selected from precursors of perbenzoic acid, cationic peroxyacid precursors, peracetic acid, sodium acetoxybenzene sulfonate, pentaacetylglucose, sodium 3,5,5-trimethylhexanoyloxybenzene sulfonate (iso-NOBS), sodium nonanoyloxybenzene sulfonate (NOBS), amide substituted alkyl peroxyacid precursors, benzoxazin peroxyacid precursors and mixtures thereof. The bleach may comprise E-phthalimidoperoxycaproic acid/phthaloiminoperoxyhexanoic acid (PAP).

The detergent or cleaning composition may comprise a rheology modifier. The rheology modifier may be non-polymeric crystalline hydroxy functional materials, polymeric rheology modifiers and/or mixtures thereof. Specific examples of suitable crystalline, hydroxyl-containing rheology modifiers include castor oil and derivatives thereof. Practical rheology modifier are hydrogenated castor oil derivatives, in particular hydrogenated castor oil and hydrogenated castor wax.

The detergent or cleaning composition may comprise a builder. Suitable builders include polycarboxylate builders include cyclic compounds, particularly alicyclic compounds. In particular, citrate builders, e.g., citric acid and soluble salts thereof, particularly sodium salts thereof are suitable builder. The builder may be aminocarboxylate builders, preferably selected from salts of MGDA (methyl-glycine-diacetic acid), EDDS (ethylene diamine disuccinates), GLDA (glutamic-N,N-diaceticacid), iminodisuccinic acid (IDS), and/or carboxymethyl inulin.

The detergent or cleaning composition may comprise a hueing dye, a brightener or a mixture thereof.

The detergent or cleaning composition may comprise a non-aqueous solvent, in particular between 5% and 30%, more particularly between 7% and 25% by weight of the detergent or cleaning composition of a non-aqueous solvent. In particular, the non-aqueous solvent is selected from glycerol, ethylene glycol, 1,3 propanediol, 1,2 propanediol, polyethylene glycol, tetramethylene glycol, hexamethylene glycol, 2,3-butane diol, 1,3 butanediol, diethylene glycol, pentamethylene glycol, polypropylene glycol, triethylene glycol, glycerol formal dipropylene glycol, dipropylene glycol n-butyl ether, and mixtures thereof.

The detergent or cleaning composition may comprise water. In particular, the detergent or cleaning composition may comprise from 0.1% to 20%, more particularly from 0.5% to 15%, most particularly from 1% to 13.5% by weight of the detergent or cleaning composition of water.

Alternatively, the detergent or cleaning composition comprises lower amounts of nonaqueous solvent, such as between 0% to 15%, more preferably 0.1% to 13% by weight, even more preferably 1% to 11% by weight of the detergent or cleaning composition of a nonaqueous solvent. In this case, the detergent or cleaning composition may comprise water in an amount of 20% to 80% by weight, preferably 25% to 75% by weight and more preferably 27.5% to 70% by weight of the detergent or cleaning composition of water.

In a particular embodiment, the perfumed consumer product also comprises an aversive agent.

According to a particular embodiment, the perfumed consumer product may be in the form of a scent booster formulation.

In a particular embodiment, the scent booster composition may comprise 35 to 37% by weight of a polyethylene glycol, 20 to 23% by weight of a polyalkylene polymer of formula: H—(C₂H₄O)ₓ—(CH(CH₃)CH₂O)_{y}—(C₂—H₄O)_{z}—OH wherein x is from 50 to 300; y is from 20 to 100, and z is from 10 to 200; 10 to 12% by weight of a polyethylene glycol fatty acid ester of formula: (C₂H₄O)_{q}—C(O)O—CH₂)ₙCH₃; wherein q is from 20 to 200, and r is from 10 to 30; 3 to 5% by weight of a polyethylene glycol fatty alcohol ether of formula: HO—(C₂H₄O)ₛ(CH₂)ₜ—CH₃ wherein s is from 30 to 250, and t is from 10 to 30; 2 to 4% by weight free fragrance; 3 to 5% by weight encapsulated fragrance; and 0.1 to 1% by weight glycerin.

In a particular embodiment, scent booster composition may comprise sodium chloride 60 to 80% by weight, such as 76.695% by weight, polyacrylic polymer 0.01 to 4% by weight, such as 0.8% by weight, perfuming agent 0.5 to 20% by weight, such as 9% by weight, dye 0.0001 to 1% by weight, such as 0.005% by weight, zeolite 0.5 to 8% by weight, such as 3% by weight, trisodium salt of the methylglycinediacetic acid 0.01 to 8% by weight, such as 3% by weight, tetrasodium salt of the GLDA 0.01 to 7% by weight, such as 2% by weight, sulfonated polymer 0.001 to 3% by weight, such as 0.2% by weight, sodium salt of the maleic/acrylic acid copolymer 0.01 to 5% by weight, such as 2% by weight, and amorphous silicon 0.001 to 4% by weight, such as 0.3% by weight.

In a particular embodiment, the perfumed consumer product is in form of unit dosage article.

Unit dosage articles offer effective and efficient means of dosing appropriate levels of detergent or cleaning compositions to the wash. Typically, the unit dosage articles come in the form of small pouches, preferably made of water-soluble substrates, where the pouches contain concentrated detergent or cleaning compositions. Often, multiple substrates, typically having the same composition, are joined together to form the unit dosage article.

In a particular embodiment, the perfumed consumer product is a laundry care, a dish care or a household care product.

In a particular embodiment, the perfumed consumer product is selected from the group consisting of liquid or solid detergent, preferably a liquid or solid dishwash detergent, liquid or solid fabric softener, liquid or solid fabric refresher, more preferably a machine wash/laundry liquid or powder detergent.

According to a particular embodiment, the perfumed consumer product may be in the form of a fabric softener composition comprising dialkyl quaternary ammonium salts, dialkyl ester quaternary ammonium salts (esterquats), Hamburg esterquat (HEQ), TEAQ (triethanolamine quat), silicones, cationic guars and mixtures thereof, preferably in an amount comprised between 85 and 99.95% by weight based on the total weight of the composition,

According to a particular embodiment, the perfumed consumer product may be in the form of a liquid detergent composition comprising anionic surfactant such as alkylbenzenesulfonate (ABS), secondary alkyl sulfonate (SAS), primary alcohol sulfate (PAS), lauryl ether sulfate (LES), methyl ester sulfonate (MES) and nonionic surfactant such as alkyl amines, alkanolamide, fatty alcohol poly(ethylene glycol) ether, fatty alcohol ethoxylate (FAE), ethylene oxide (EO) and propylene oxide (PO) copolymers, amine oxydes, alkyl polyglucosides, alkyl polyglucosamides, preferably in an amount comprised between 85 and 99.95% by weight based on the total weight of the composition,

According to a particular embodiment, the perfumed consumer product may be in the form of a solid detergent composition comprising anionic surfactant such as alkylbenzenesulfonate (ABS), secondary alkyl sulfonate (SAS), primary alcohol sulfate (PAS), lauryl ether sulfate (LES), methyl ester sulfonate (MES) and nonionic surfactant such as alkyl amines, alkanolamide, fatty alcohol poly(ethylene glycol) ether, fatty alcohol ethoxylate (FAE), ethylene oxide (EO) and propylene oxide (PO) copolymers, amine oxydes, alkyl polyglucosides, alkyl polyglucosamides, preferably in an amount comprised between 85 and 99.95% by weight based on the total weight of the composition,

According to a particular embodiment, the perfumed consumer product may be in the form of a solid scent booster comprising:
a solid carrier, preferably chosen in the group consisting of urea, sodium chloride, sodium sulphate, sodium acetate, zeolite, sodium carbonate, sodium bicarbonate, clay, talc, calcium carbonate, magnesium sulfate, gypsum, calcium sulfate, magnesium oxide, zinc oxide, titanium dioxide, calcium chloride, potassium chloride, magnesium chloride, zinc chloride, saccharides such as sucrose, mono-, di-, and polysaccharides and derivatives such as starch, cellulose, methyl cellulose, ethyl cellulose, propyl cellulose, polyols/sugar alcohols such as sorbitol, maltitol, xylitol, erythritol, and isomalt, PEG, PVP, citric acid or any water soluble solid acid, fatty alcohols or fatty acids and mixtures thereof.

According to a particular embodiment, the perfumed consumer product may be in the form of a liquid scent booster comprising:
an aqueous phase,
a surfactant system essentially consisting of one or more than one non-ionic surfactant, wherein the surfactant system has a mean HLB between 10 and 14, preferably chosen in the group consisting of ethoxylated aliphatic alcohols, POE/PPG (polyoxyethylene and polyoxypropylene) ethers, mono and polyglyceryl esters, sucrose ester compounds, polyoxyethylene hydroxylesters, alkyl polyglucosides, amine oxides and combinations thereof;
a linker chosen in the group consisting of alcohols, salts and esters of carboxylic acids, salts and esters of hydroxyl carboxylic acids, fatty acids, fatty acid salts, glycerol fatty acids, surfactant having an HLB less than 10 and mixtures thereof, and

The present invention also relates to the use of a perfumed consumer product as defined herein-above to confer, enhance, improve or modify a perfuming effect of an article.

In a particular embodiment, an article relates to the skin, a fabric, clothes, hair.

The present invention also relates to a method to confer, enhance, improve or modify a perfuming effect of an article, the method comprises the step of applying to the article a perfuming effective amount of the perfumed consumer product as defined herein-above.

### EXAMPLES

The present invention will be described in further detail by way of the following non-limiting examples.

### Example 1: Composition of Perfume Used in the Present Invention

| Chemical name | Amount (% wt) |
|---|---|
| Hexyl acetate | 0.50% |
| 1,3,3-trimethyl-2-oxabicyclo[2.2.2]octane | 1% |
| (2-methoxyethyl)benzene | 1% |
| Alpha-terpineol | 22% |
| 4-phenyl-2-butanone | 3% |
| (E)-4-methyl-3-decen-5-ol | 7% |
| 2-methylundecanal | 5% |
| (2E)-1-[(1RS,2SR)-2,6,6-trimethyl-3-cyclohexen- | 1% |
| 1-yl]-2-buten-1-one | |
| Dodecanal | 2% |
| Tricyclo[5.2.1.0^{2,6}]dec-3/4-en-8-yl acetate | 12% |
| (2Z)-2-phenyl-2-hexenenitrile | 8% |
| (+−)-(E)-3-methyl-4-(2,6,6-trimethyl-2-cyclohexen- | 1% |
| 1-yl)-3-buten-2-one | |
| 1-(octahydro-2,3,8,8-tetramethyl-2-naphtalenyl)- | 13% |
| 1-ethanone | |
| Hexyl 2-hydroxybenzoate | 8% |
| Cyclohexylidene(phenyl)acetonitrile | 7% |
| Pentadecenolide | 9.5% |

### Composition of Perfume B:

| Chemical name | Amount (% wt) |
|---|---|
| Limonene | 3% |
| 3,7-dimethyl-1,6-octadien-3-ol | 4% |
| Benzyl acetate | 1% |
| Alpha-terpineol | 1% |
| 3,7-dimethyl-6-octen-1-ol | 1% |
| 4-methoxybenzaldehyde | 3% |
| 1,5-dimethyl-1-vinyl-4-hexenyl acetate | 3% |
| 2-(2-methyl-2-propanyl)cyclohexyl acetate | 4% |
| Benzo[d][1,3]dioxole-5-carbaldehyde | 2% |
| 4-(2-methyl-2-propanyl)cyclohexyl acetate | 9% |
| 2-chromenone | 4% |
| Tricyclo[5.2.1.0^{2,6}]dec-3/4-en-8-yl acetate | 4% |
| 3-ethoxy-4-hydroxybenzaldehyde | 6% |
| 4-decanolide | 4% |
| Ethyl (e)-3-phenyl-2-propenoate | 1% |
| (2Z)-2-phenyl-2-hexenenitrile | 1% |
| (3E)-4-(2,6,6-trimethyl-1-cyclohexen-1-yl)-3-buten-2-one | 2% |
| (+−)-3-methyl-5-phenyl-1-pentanol | 0.50% |
| (+−)-2-methyl-3-[4-(2-methyl-2-propanyl)phenyl]pro- | 7% |
| panal | |
| (+−)-5-heptyldihydro-2(3H)-furanone | 1% |
| (E)-2-pentyl-3-phenyl-2-propenal | 9% |
| 1-(octahydro-2,3,8,8-tetramethyl-2-naphtalenyl)-1- | 5% |
| ethanone | |
| Hexyl 2-hydroxybenzoate | 6% |
| (2E)-2-benzylideneoctanal | 7% |
| (−)-(3ar,5as,9as,9br)-3a,6,6,9a- | 1% |
| tetramethyldodecahydronaphtho[2,1-b]furan | |
| Acetylcedrene | 4% |
| Pentadecenolide | 1% |
| Benzyl 2-hydroxybenzoate | 3.50% |
| Methyl dihydrojasmonate | 5% |

### Composition of Perfume C:

| Chemical name | Amount (% wt) |
|---|---|
| 1-pentyl-2-propenyl acetate | 0.31% |
| 1,5-dimethyl-1-vinyl-4-hexenyl acetate | 24.56% |
| (+)-(1R,2R,4S)-1,3,3-trimethylbicyclo[2.2.1]heptan-2-ol | 0.15% |
| (1S,2S/2R,4S)-1,7,7-trimethylbicyclo[2.2.1]heptan-2-ol | 1.93% |
| 2,2-dimethyl-3-methylene-bicyclo[2.2.1]heptane | 0.39% |
| 1,7,7-trimethylbicyclo[2.2.1]heptan-2-one | 5.39% |
| 1-octen-3-ol | 0.39% |
| 2,6-dimethyl-7-octen-2-ol | 15.40% |
| 3,7-dimethyl-1-octanol | 0.01% |
| 4-(2-methyl-2-propanyl)cyclohexyl acetate | 1.54% |
| 5-methyl-3-heptanone | 0.01% |
| 1,3,3-trimethyl-2-oxabicyclo[2.2.2]octane | 11.55% |
| 3,4,5,6,6-pentamethylhept-3-en-2-one | 0.01% |
| 3,7-dimethyl-1,6-octadien-3-ol | 9.24% |
| 2,6-dimethyl-5-heptenal | 0.04% |
| 6-methyl-5-hepten-2-one | 0.39% |
| 2-octanone | 1.16% |
| 7-methyl-3-methylene-1,6-octadiene | 0.39% |
| (2,2-dimethyl-3-[3-methyl-2,4-pentadien-1-yl]oxirane | 0.77% |
| 2-(tetrahydro-5-methyl-5-vinyl-2-furyl)-2-propanol | 0.77% |
| 1-isopropyl-4-methylbenzene S | 0.23% |
| (2E,6Z)-2,6-nonadienal | 0.00% |
| Apha/beta-pinene | 0.77% |
| (Z)-3-hexen-1-ol | 0.01% |
| 1-methyl-4-(2-propanyl)-1,4-cyclohexadiene | 0.08% |
| Alpha-terpineol | 1.54% |
| (E)-3,7-dimethyl-2,6-octadienylhexadecanoate | 20% |
| Triethanolamine | 3% |

### Example 2: Preparation of a Low-Aqueous Liquid Detergent Format in Single and Dual Chamber Pods

The model liquid base used was a low water liquid detergent composed of C12-15 pareth 7, MEA-hydrogenated cocoate, MEA-dodecylbenzene sulfonate, propylene glycol, glycerine water, polyvinyl alcohol, polypropylene terephthalate polyoxyoethylene terephthalate, sorbitol, sodium diethyenetriamin pentamethylene phosphonate, MEA-sulfate, potassium sulfite, ethynolamine, peptide salt, glycol, subtilisin, perfume, disodium distyrybiphenyl disulfonate, talc, amylase, lipase, sodium chloride, denatonium benzoate, disubstitued alaninamide, dye, mannanase. In range term this composition contains 5-15% anionic surfactants, nonionic surfactant, soap and less than 5% enzymes mix without lipase, optical brightener, perfume, phosphonate. Base pH should be above >7.

A 27 g single chamber liquid base detergent formulation was prepared according to the formulation above and lipase (0.01 g) was added. To this formulation was added Perfume A (0.54 g) and (E)-3,7-dimethyl-2,6-octadienylhexadecanoate (0.88 g). This formulation is introduced into a polyvinylalcohol pouch.

A dual chamber liquid base detergent formulation was also prepared in order to get a 20 g perfumed chamber without lipase and a 7 g unperfumed chamber with lipase (0.01 g). To the 20 g chamber, perfume A (0.54 g) and (E)-3,7-dimethyl-2,6-octadienylhexadecanoate (0.88 g) were added to deliver the same quantity of perfume & lipase per wash compared to the single chamber pouch. These formulations are introduced into a dual-polyvinylalcohol pouch

### Example 3: Storage Stability of (E)-3,7-dimethyl-2,6-octadienylhexadecanoate in a Low-Aqueous Liquid Detergent Format

a. Protocol

The stability of (E)-3,7-dimethyl-2,6-octadienylhexadecanoate was studied in a low-aqueous liquid detergent base in pods under two formats prepared according to example 2, namely single and dual chambers in order to separate the lipase from the pro-perfume.

The quantity of 3,7-dimethyl-2,6-octadien-1-ol released by lipase-induced cleavage of (E)-3,7-dimethyl-2,6-octadienylhexadecanoate was measured over time at both 22° C. and 35° C. by GC/MS, allowing us to determine how much (E)-3,7-dimethyl-2,6-octadienylhexadecanoate had been decomposed.

b. Results

Results are summarized in Table 1 herein below.

TABLE 1
Analytical stability of (E)-3,7-dimethyl-2,6-octadienylhexadecanoate
according to the invention

| | % of original (E)-3,7-dimethyl-2,6- | | | |
|---|---|---|---|---|
| | octadienylhexadecanoate remaining | | | |
| | after storage in liquid base | | | |
| | detergent formulation | | | |
| | 22° C. | | 35° C. | |
| | 3 days | 14 days | 3 days | 14 days |
| In monochamber format | 11% | 10% | 11% | 6% |
| In dual chamber format | 98% | 98% | 98% | 98% |

c. Conclusion

It can be concluded that (E)-3,7-dimethyl-2,6-octadienylhexadecanoate loss upon storage in a single chamber pods product containing lipase was quite high under both soft (22° C.) and stressed (35° C.) storage conditions. Indeed, in both cases, after only 3 days there was almost a full degradation of the properfume. Nevertheless, in the dual chamber pods format where (E)-3,7-dimethyl-2,6-octadienylhexadecanoate in one chamber was separated from lipase in another chamber, stability of (E)-3,7-dimethyl-2,6-octadienylhexadecanoate was excellent.

### Example 4: Olfactive Performance of (E)-3,7-dimethyl-2,6-octadienylhexadecanoate in a Liquid Base Detergent Formulation in Pods

The olfactive performance of (E)-3,7-dimethyl-2,6-octadienylhexadecanoate was studied in a low-aqueous liquid detergent base under two formats prepared according to example 2, namely single and dual chambers pods in order to separate the lipase from the pro-perfume.

a. Protocol

Fabrics (2.0 kg of cotton terry towels) were washed at 40° C. in a standard European horizontal axis machine (Miele Novotronic W 900-79 CH) using one chamber and dual chambers pods as prepared in example A previously put on storage for 2 weeks at 37° C.

The pod comprising one or two chambers was placed in the drum of the washing machine at the start of the wash. After the wash, fabrics were line-dried overnight before the odor intensity of the cotton towels was evaluated by a panel of 20 trained panelists. The panelists were asked to rate the odor intensity of the towels on a scale from 1 to 7, 1 corresponding to odorless and 7 corresponding to a very strong odor.

b. Results

The results are shown in Table 2 herein below.

TABLE 2
Olfactive performance of (E)-3,7-dimethyl-2,6-octadienylhexadecanoate
according to the invention

| Overall Perfume Intensity | Line Drying |
|---|---|
| Aged Samples 2 weeks at 37° C. | 3 days |
| 27g Single compartment with perfume A @2% + | 2.4 |
| (E)-3,7-dimethyl-2,6-octadienylhexadecanoate | |
| in an amount of 3.24% | |
| Dual compartment:, one with 20 g base with | 3.1 |
| perfume A in an amount of 2.7% + (E)-3,7- | |
| dimethyl-2,6-octadienylhexadecanoate in an | |
| amount of 4.4% and a 2^{nd} with 7 g unperfumed | |
| base but with lipase | |

c. Conclusions

The overall perfume intensity on dry fabrics due to (E)-3,7-dimethyl-2,6-octadienylhexadecanoate is significantly stronger for the fabrics that have been washed with the dual compartment chamber. Having the lipase and the pro-perfume formulated in separate chamber was bringing an additional benefit as the pro-perfume remains stable in the product while it was actually unstable when there was only one chamber.

### Example 5: Storage Stability of (E)-3,7-dimethyl-2,6-octadienyl hexadecanoate in a Liquid Base Detergent

TABLE 3
Composition of the liquid detergent formulation

| Ingredients | Concentration [wt %] |
|---|---|
| Sodium C14-17 Alkyl Sec Sulfonate¹⁾ | 7 |
| Fatty acids, C12-18 and C18-unsaturated²⁾ | 7.5 |
| C12/14 fatty alcohol polyglycol ether with | 17 |
| 7 mol EO³⁾ | |
| Triethanolamine | 7.5 |
| Propylene Glycol | 11 |
| Citric acid | 6.5 |
| Potassium Hydroxyde | 9.5 |
| Protease | 0.2 |
| Amylase | 0.2 |
| Mannanase | 0.2 |
| Acrylates/Steareth-20 Methacrylate | 6 |
| structuring Crosspolymer⁴⁾ | |
| Deionized Water | 27.4 |

¹⁾Hostapur SAS 60; Origin: Clariant
²⁾Edenor K 12-18; Origin: Cognis
³⁾Genapol LA 070; Origin: Clariant
⁴⁾Aculyn 88; Origin: Dow Chemical

a. Protocol

The stability of (E)-3,7-dimethyl-2,6-octadienylhexadecanoate was studied in a liquid base detergent formulation as reported in Table 4. This detergent formulation was added in a single compartment bottle or in a dual compartment bottle. In case of single compartment bottle, lipase and (E)-3,7-dimethyl-2,6-octadienylhexadecanoate were added into the bottle. In the case of a dual compartment bottle, detergent was introduced in both compartments wherein in one compartment lipase was added and in the second compartment (E)-3,7-dimethyl-2,6-octadienylhexadecanoate was added.

(E)-3,7-dimethyl-2,6-octadienylhexadecanoate concentration in the liquid base detergent formulation was equivalent to 1%. The quantity of geraniol released by lipase-induced cleavage of (E)-3,7-dimethyl-2,6-octadienylhexadecanoate was measured over time at both 22° C. and 35° C. by GC/MS, allowing us to determine how much (E)-3,7-dimethyl-2,6-octadienylhexadecanoate had been decomposed.

b. Results

Results are summarized in Table 4 herein below.

TABLE 4
Analytical stability of (E)-3,7-dimethyl-2,6-octadienylhexadecanoate
according to the invention

| | % of original (E)-3,7-dimethyl-2,6- | | | |
|---|---|---|---|---|
| | octadienylhexadecanoate remaining | | | |
| | after storage in liquid base | | | |
| | detergent formulation | | | |
| | 22° C. | | 35° C. | |
| | 3 days | 14 days | 3 days | 14 days |
| Dual chamber PET bottle | 99.5% | 99% | 98.5% | 98.5% |
| Single chamber PET bottle | 10% | 10% | 0% | 0% |

c. Conclusion

It can be concluded that (E)-3,7-dimethyl-2,6-octadienylhexadecanoate loss upon storage in a liquid detergent containing lipase was quite high under both soft (22° C.) and stressed (35° C.) storage conditions. Indeed, in both cases, after only 3 days there was almost a full degradation of the properfume. Nevertheless, if the liquid detergent was contained in a dual chamber PET bottle where (E)-3,7-dimethyl-2,6-octadienylhexadecanoate in one chamber was separated from lipase in another chamber, stability of (E)-3,7-dimethyl-2,6-octadienylhexadecanoate was excellent.

### Example 6: Storage Stability of (E)-3,7-dimethyl-2,6-octadienylhexadecanoate in a Powder Detergent

a. Composition

The test was carried out using a basic powder detergent formula comprising sodium sulfate, sodium carbonate, sodium dodecylbenzensulfonate, sodium silicate, zeolite, C₁₂₋₁₅ pareth-7, bentonite, citric acid, Sodium Acrylic Acid/MA Copolymer, sodium carbonate peroxide, tetrasodium etidronate, sodium chloride, sodium bicarbonate, cellulose gum, Disodium Anilinomorpholinotriazinylaminostilbenesulfonate, Phenylpropyl Dimethicone, enzyme (without lipase), dye in the following amount:

| Ingredient | % |
|---|---|
| Anionic surfactant | 5-25% |
| Non ionic surfactant | 2-15% |
| Builder: | 20-50% |
| Polymer | 3-10% |
| Optical brightener | 0.1-0.5% |
| Enzyme, Dye | <2% |

To the powder detergent formula, 0.7% of perfume B and 0.5% of (E)-3,7-dimethyl-2,6-octadienylhexadecanoate were added and the mixture was mixed. Then 0.4% of either the liquid lipase or granulated lipase was added to the perfumed powder detergent base and the mixture was mixed

b. Protocol

24 cotton terry towels were washed at 40° C. in a standard European horizontal axis machine (Miele Novotronic W 900-79 CH) in presence of 80 g of perfumed bio powder detergent. The powder was delivered through drawer of the washing machine. After the wash, fabrics were line-dried overnight before the odor intensity of the cotton towels was evaluated by a panel of expert panelists. The panelists were asked to rate the odor intensity of the towels on a scale from 1 to 7, 1 corresponding to odorless and 7 corresponding to a very strong odor.

c. Results

The results are shown in Table 5 herein below.

TABLE 5
Olfactive performance of (E)-3,7-dimethyl-2,6-octadienylhexadecanoate
according to the invention

| Overall Perfume Intensity | Line Drying | | |
|---|---|---|---|
| Powder detergent aged 2 weeks @37° C. | 1 day | 3 days | 7 days |
| Powder detergent base without lipase | 2.5 | 2.5 | 2.5 |
| Powder detergent base containing lipase | 2.5 | 2.55 | 2.6 |
| in liquid form | | | |
| Powder detergent base containing granulated | 3 | 3.5 | 3.5 |
| lipase | | | |

d. Conclusion

After drying, the powder detergent base comprising granulated lipase was perceived stronger that the equivalent base without lipase or with lipase in direct contact with the properfume in the powder detergent whatever the evaluation stage (1, 3 & 7 days dry fabrics). The liquid lipase was in direct contact with the properfume in the powder detergent, as a consequence the performance was lost upon storage for 2 weeks at 37° C. as the properfume got decomposed by its trigger. Like liquid enzyme when using granulated lipase alongside the powder detergent containing the properfume, the stability and performance of (E)-3,7-dimethyl-2,6-octadienylhexadecanoate was still good even after an intensive storage test of 2 weeks at 37° C.

### Example 7: Olfactive Performance of (E)-3,7-dimethyl-2,6-octadienylhexadecanoate in urea-Based Granulated Base

a. Composition

The urea-based granulated base formula with the following final composition was prepared.

| Ingredients | Part |
|---|---|
| Urea (beads) | 77.45 |
| Bentonite | 11 |
| Perfume B | 6 |
| (E)-3,7-dimethyl-2,6-octadienylhexadecanoate | 5 |
| Granulated lipase¹⁾ | 0.55 |

¹⁾DETE-2624 Alkaline Lipase for detergent, powder form, from creative Enzyme

To the urea beads, 6% of perfume B and 5% of (E)-3,7-dimethyl-2,6-octadienylhexadecanoate were added and the mixture was tumble-mixed. Then Bentonite and was added to the perfumed urea beads and the mixture was tumble-mixed. Finally, the lipase was added in either granulated or liquid form, and mixed by tumble-mixing, such that the urea and bentonite surfaces were fully covered by the perfume, (E)-3,7-dimethyl-2,6-octadienylhexadecanoate and lipase.

b. Protocol

24 cotton terry towels were washed at 40° C. in a standard European horizontal axis machine (Miele Novotronic W 900-79 CH in presence of 36 g of unperfumed non bio powder detergent and 18 g of granulated base formula prepared in example 7 a) that was aged for 2 weeks in the oven at 37° C. The powder was delivered through drawer of the washing machine the while the granulated base formula was placed in the drum of the washing machine at the start of the wash. After the wash, fabrics were line-dried overnight before the odor intensity of the cotton towels was evaluated by a panel of 10 expert panelists. The panelists were asked to rate the odor intensity of the towels on a scale from 1 to 7, 1 corresponding to odorless and 7 corresponding to a very strong odor.

c. Results

The results are shown in Table 6 herein below.

TABLE 6
Olfactive performance of (E)-3,7-dimethyl-2,6-octadienylhexadecanoate
according to the invention

| Overall Perfume Intensity | Line Drying | | |
|---|---|---|---|
| Granulated urea base aged 2 weeks at 37° C. | 1 day | 3 days | 7 days |
| Granulated urea base without lipase | 3 | 3.5 | 3.5 |
| Granulated urea base containing liquid | 3 | 3.5 | 3.5 |
| Lipase | | | |
| Granulated urea base containing granulated | 4 | 4 | 4 |
| Lipase | | | |

d. Conclusion

In the granulated urea base, performance on 1 dry fabric due to (E)-3,7-dimethyl-2,6-octadienylhexadecanoate was slightly stronger when the base contains granulated lipase than for the base without any lipase or with free, liquid lipase, even after a very stringent storage test of 2 weeks at 37° C., again indicating that thanks to the separation of the properfume from its granulated lipase trigger, enough properfume survived the very stringent storage test of 2 weeks at 37° C.

### Example 8: Olfactive Performance of (E)-3,7-dimethyl-2,6-octadienylhexadecanoate in Granulated PEG Base

a. Composition

The granulated PEG base formula with the following final composition was prepared.

| Ingredients | Part |
|---|---|
| PEG 4000 - 7500 | 62.6 |
| Dextrose | 26 |
| Perfume B | 6 |
| (E)-3,7-dimethyl-2,6-octadienylhexadecanoate | 5 |
| Granulated lipase¹⁾ | 0.4 |

¹⁾DETE-2624 Alkaline Lipase for detergent, powder form, from Creative Enzyme

To the PEG base, 26% of dextrose were added and the mixture was melted at 80° C. Then 6% of perfume B and 5% of (E)-3,7-dimethyl-2,6-octadienylhexadecanoate were added and mixed. Finally, the lipase was added in either granulated or liquid form, and gently mixed to maintain the integrity of the lipase granules. The mix is then pelletised while cooling, by pouring a thin film of the molten mixture on a flat surface and cutting it in smaller pieces after solidification.

b) Protocol

24 cotton terry towels were washed at 40° C. in a standard European horizontal axis machine (Miele Novotronic W 900-79 CH in presence of 36 g of unperfumed non bio powder detergent and 18 g of granulated base formula prepared in example 8 a) that was aged for 2 weeks in the oven at 37° C. The powder was delivered through drawer of the washing machine, while the granulated base formula was placed in the drum of the washing machine at the start of the wash. After the wash, fabrics were line-dried overnight before the odor intensity of the cotton towels was evaluated by a panel of 10 expert panelists. The panelists were asked to rate the odor intensity of the towels on a scale from 1 to 7, 1 corresponding to odorless and 7 corresponding to a very strong odor.

c) Results

The results are shown in Table 7 herein below.

TABLE 7
Olfactive performance of (E)-3,7-dimethyl-2,6-octadienylhexadecanoate
according to the invention

| Overall Perfume Intensity | Line Drying | | |
|---|---|---|---|
| granulated PEG base aged 2 weeks at 37° C. | 1 day | 3 days | 7 days |
| Pelletized PEG base without lipase | 3.5 | 3.5 | 4 |
| Pelletized PEG base containing liquid | 3.5 | 3.5 | 4 |
| lipase | | | |
| Pelletized PEG base containing granulated | 4 | 5 | 5.5 |
| lipase | | | |

d) Conclusion

After drying, the granulated PEG base comprising granulated lipase was outperforming the equivalent base without lipase or with lipase in direct contact with the properfume in the PEG granule across all stages evaluated (1, 3 & 7 days dry fabrics). When the lipase in direct contact with the properfume in the PEG granule all performance was lost upon storage as the properfume is decomposed by its trigger. By contrast, when using granulated lipase alongside the PEG granules containing the properfume, even though the lipase was in the same product as (E)-3,7-dimethyl-2,6-octadienylhexadecanoate, as it is under granulated form the stability and performance of (E)-3,7-dimethyl-2,6-octadienylhexadecanoate was not affected even after a very stringent storage test of 2 weeks at 37° C.

### Example 9: Storage Stability of nona-2,6-dien-1-yl palmitate in a Liquitabs Format

a) Protocol

The stability of nona-2,6-dien-1-yl palmitate was studied in a liquitabs base under two formats: single & dual chambers in order to separate the lipase from the properfume.

The model liquitabs base used was a low water liquid detergent composed of C12-15 pareth 7, MEA-hydrogenated cocoate, MEA-dodecylbenzene sulfonate, propylene glycol, glycerine water, polyvinyl alcohol, polypropylene terephthalate polyoxyoethylene terephthalate, sorbitol, sodium diethyenetriamin pentamethylene phosphonate, MEA-sulfate, potassium sulfite, ethynolamine, peptide salt, glycol, subtilisin, perfume, disodium distyrybiphenyl disulfonate, talc, amylase, lipase, sodium chloride, denatonium benzoate, disubstitued alaninamide, dye, mannanase. In range term this composition contains 5-15% anionic surfactants, nonionic surfactant, soap and less than 5% enzyme, optical brightener, perfume, phosphonate. Base pH should be above pH 7.

Nona-2,6-dien-1-yl palmitate concentration in liquitabs was equivalent to 1%. The quantity of 2,6-nonadien-1-ol released was measured over time at RT by GC/MS.

b) Results

The results are shown in Table 8 below.

TABLE 8
Analytical release of 2,6-nonadien-1-ol from nona-
2,6-dien-1-yl palmitate according to the invention

| | % 2,6-nonadien-1-ol released from | | | |
|---|---|---|---|---|
| | nona-2,6-dien-1-yl palmitate in | | | |
| | liquitabs base | | | |
| | Time in minute at RT | | | |
| | 2 | 15 | 30 | 60 |
| In monochamber format | 5 | 24 | 44 | 69 |
| In dual chamber format | 0 | 0 | 0 | 0 |

c) Conclusion

The monochamber liquitabs containing lipase showed weak stability of nona-2,6-dien-1-yl palmitate. After only few minutes within the formulation, the degradation started and there was already about 70% of 2,6-nonadien-1-ol released after only 1 hour. However, in the dual chamber liquitabs where nona-2,6-dien-1-yl palmitate was physically separated from lipase in two different chambers no instability has been observed at all.

### Example 10: Olfactive Performance of nona-2,6-dien-1-yl palmitate in Liquitabs

a. Composition

Same as above in Example 9 above.

b. Protocol

Fabrics (2.0 kg of cotton terry towels) were washed at 40° C. in a standard European horizontal axis machine (Miele Novotronic W 900-79 CH) using samples put on storage for 2 weeks at 37° C. A 27 g single chamber liquitabs was prepared according to the formulation above into a polyvinylalcohol pouch and was perfumed with Perfume A in an amount of 2% and nona-2,6-dien-1-yl palmitate in an amount of 3.24%. A dual chamber liquitabs was also prepared in order to get a 20 g perfumed compartment without lipase & a 7 g unperfumed compartment with lipase. The dosages were adjusted accordingly (Perfume A in an amount of 2.7% and nona-2,6-dien-1-yl palmitate in an amount of 4.4%) to deliver the same quantity of perfume and lipase per wash.

The pod was placed in the drum of the washing machine at the start of the wash. After the wash, fabrics were line-dried overnight before the odor intensity of the cotton towels was evaluated by a panel of 20 trained panelists. The panelists were asked to rate the odor intensity of the towels on a scale from 1 to 7, 1 corresponding to odorless and 7 corresponding to a very strong odor.

c. Results

The results are shown in Table 9 below.

TABLE 9
Olfactive performance of nona-2,6-dien-1-yl
palmitate according to the invention

| Overall Perfume Intensity | Line Drying | |
|---|---|---|
| Samples stored 2 weeks at 37° C. | 3 days | 7 days |
| 27 g Single compartment with perfume A in an | 2.37 | 2.91 |
| amount of 2% + nona-2,6-dien-1-yl palmitate in | | |
| an amount of 3.24% | | |
| Dual compartment, one with: 20 g unperfumed | 3.08 | 3.78 |
| base with perfume A in an amount of 2.7% + | | |
| nona-2,6-dien-1-yl palmitate in an amount of | | |
| 4.4% and a 2^{nd} one with 7 g unperfumed base but | | |
| with lipase | | |

d. Conclusions

The overall perfume intensity on dry fabrics due to nona-2,6-dien-1-yl palmitate was significantly stronger for the fabrics that have been washed with the dual compartment chamber. Having the lipase and the properfume formulated in separate chamber was bringing an additional benefit as the properfume remains stable in the product while it is actually unstable when there is only one chamber.

### Example 11: Olfactive Performance of (E)-3,7-dimethyl-2,6-octadienylhexadecanoate in Monochamber Liquitabs

a. Composition

Same as in Example 9 above.

b. Capsule Preparation

Synthesis of the Microcapsules

| | Capsules |
|---|---|
| Ingredient | [%] |
| Oil Phase | 29.62 |
| Perfume C | 29 |
| trimethylol propane adduct of xylylene diisocyanate¹⁾ | 0.62 |
| Water phase | 70.38 |
| Acrylamide and acrylic acid copolymer²⁾ | 4.7 |
| Melamine-formaldehyde resins ³⁾ | 2.45 ³⁾ |
| Water | 51.83 |
| Sodium hydroxide | 0.5 |
| Acetic acid | 0.2 |
| Water or 3% acrylamidopropyltrimonium chloride/ | 10.7 cationic |
| acrylamide copolymer solution ⁴⁾ | Solution |
| Total | 100 |

¹⁾Takenate ® D110N (75% active solution in ethyl acetate)
²⁾ Alcapsol from Ciba, 20% solution in water
³⁾ 90/10 blend of Cymel 385 & Cymel 9370 from Cytec, both 70% solution in water
⁴⁾ Salcare SC60 from Ciba, 3% solution in water

The oil phase was prepared by admixing a polyisocyanate (trimethylol propane adduct of xylylene diisocyanate, Takenate® D-110N, origin: Mitsui Chemicals) with a core oil composed of a perfume oil. The oil phase consisted of 2% Takenate® D-110N and 98% of core oil. After encapsulation and use of the Takenate D-110N to cross-link the melamine-formaldehyde wall, the residual level of unreacted polyisocyanate in the core oil was very low and therefore the internal core of the capsule was only made of the core oil composed of a perfume oil.

To make the capsules slurry, the acrylamide and acrylic acid copolymer and the blend of the two melamine-formaldehyde resins were dissolved in water to form the water phase. Then the perfume premix oil was added into this solution and the pH was regulated to 5 with acetic acid. The temperature was raised to 90° C. for 2 hours to allow the curing of the capsules. At this point, capsules were formed, cross-linked and stable. For the cationic polymer coated capsules B, a 3% Salcare SC60 (acrylamidopropyltrimonium chloride/acrylamide copolymer) solution in water was then added into the mixture at 90° C. and was allowed to react for 1 hour at 90° C. For the uncoated capsules A it was just water added at 90° C. before leaving the slurry for a further 1 h at 90° C. Then a solution of ethylene urea (50% wt in water) was added as usually done with aminoplast capsules as an agent to scavenge residual free formaldehyde. Final slurry contains about 3% w/w of ethylene urea relative to the weight of the slurry and the mixture was left to cool down to room temperature. The final pH was adjusted to 7 with sodium hydroxide.

c. Protocol

Fabrics (2.0 kg of cotton terry towels) were washed at 40° C. in a standard European horizontal axis machine (Miele Novotronic W 900-79 CH) using samples put on storage for 1 weeks at 50° C. A 27 g single chamber liquitabs was prepared according to the formulation above into a polyvinylalcohol pouch and was perfumed with either Perfume C at 2.4% or with capsules as prepared above at 8.3% to deliver the same quantity of perfume per wash.

The pod was placed in the drum of the washing machine at the start of the wash. After the wash, fabrics were line-dried overnight before the odor intensity of the cotton towels was evaluated by a panel of 20 trained panelists. The panelists were asked to rate the odor intensity of the towels before & after gentle rubbing of the fabrics by hand on a scale from 1 to 7, 1 corresponding to odorless and 7 corresponding to a very strong odor on day 1 and then on day 3 and 7 only before rubbing as the point was to evaluate the properfume intensity.

d. Results

The results are shown in Table 10 below.

TABLE 10
Olfactive performance according to the invention

| | | Line Drying | | |
|---|---|---|---|---|
| Overall Perfume Intensity | 1 day | 1 day | 3 days | 7 days |
| Samples stored 1 weeks at 50° C. | BR | AR | BR | BR |
| 27 g Single compartment with perfume | 1.63 | 1.76 | 1.89 | 2.21 |
| C in an amount of 2.4% | | | | |
| 27 g Single compartment with 8.3% | 3.09 | 5.01 | 3.71 | 3.49 |
| capsules containing 29% of Perfume | | | | |
| C (i.e. ⇔ 2.4% encapsulated | | | | |
| Perfume C) | | | | |

e. Conclusions

The overall perfume intensity on dry fabrics was significantly stronger for the fabrics that have been washed with the microcapsules. On day one where the fabrics were evaluated both before and after rubbing, the protection effect on the capsules over the perfume was observed.

1. A perfumed consumer product comprising a pro-perfume compound and a trigger, wherein the pro-perfume compound and the trigger are physically separated from each other by comprising
a) the pro-perfume compound or the trigger in a particle;
b) the pro-perfume compound and the trigger in different particles; or
c) the pro-perfume compound and the trigger in different compartments.

2. The perfumed consumer product according to claim 1, wherein the trigger is an enzyme.

3. The perfumed consumer product according to claim 1, wherein the pro-perfume is an enzyme cleavable pro-perfume.

4. The perfumed consumer product according to claim 1, wherein the enzyme-cleavable pro-perfume compound is a compound of formula 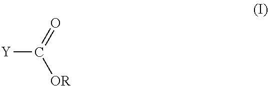
wherein
a.) R represents a monovalent radical derived from a fragrant alcohol of formula ROH and Y represents a C₇ to C₂₄ linear or branched, saturated or unsaturated hydrocarbon radical, or a —(CH₂)ₙCOOR group wherein R is defined as above and n is an integer from 0 to 6; or
b.) Y represents a C₇ to C₂₄ linear or branched, saturated or unsaturated hydrocarbon radical and R represents a group of formula 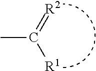
wherein, either R¹ represents hydrogen and R² represents an alkylidene radical derived from a fragrant aldehyde of formula 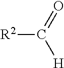
or R¹ and R² are derived from a fragrant ketone of formula 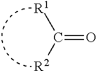
and, taken separately, represent respectively an alkyl radical and an alkylidene radical, or, taken together with their terminal C atoms, represent a substituted or unsubstituted cyclic alkyl, alkenyl, aryl or alkylaryl moiety having 5 to 18 carbon atoms in the ring, such as indicated by the dotted line.

5. The perfumed consumer product according to claim 4, wherein Y represents a —(CH₂)ₙCOOR group, R standing for a monovalent radical derived from a fragrant alcohol of formula ROH and n being an integer from 0 to 6.

6. The perfumed consumer product according to claim 1, wherein the particle is a granule or a microcapsule.

7. The perfumed consumer product according to claim 1, wherein the particle is a granule, wherein the pro-perfume compound or the trigger is dispersed or adsorbed in a matrix or carrier being a water soluble material.

8. The perfumed consumer product according to claim 1, wherein the particle is a microcapsule having a shell being aminoplast-based, polyurea-based or polyurethane-based or being a hybrid shell.

9. The perfumed consumer product according to claim 1, wherein the pro-perfume compound and the trigger are comprised in different compartments and at least one of the compartments is surrounded by a water-soluble barrier material.

10. The perfumed consumer product according to claim 9, wherein the water-soluble barrier material comprises a material selected from the group consisting of polyvinyl alcohols (PVA), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides, starch, gelatin, natural gums, xanthans carragum, polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, and polymethacrylates.

11. The perfumed consumer product according to claim 10, wherein the product is in a form of a unit dosage article.

12. The perfumed consumer product according to claim 1, wherein the product is a laundry care, a dish care or a household care product.

13. The perfumed consumer product according to claim 1, wherein the product is selected from the group consisting of liquid and solid detergent, detergent.

14. (canceled)

15. A method to confer, enhance, improve or modify a perfuming effect of an article, the method comprising the step of applying to the article a perfuming effective amount of the perfumed consumer product defined in claim 1.

16. The perfumed consumer product according to claim 1, wherein the trigger is a lipase.

17. The perfumed consumer product according to claim 1, wherein the pro-perfume is a lipase-cleavable pro-perfume compound.

18. The perfumed consumer product according to claim 4, wherein Y represents a C₇ to C₂₄ linear or branched, saturated or unsaturated hydrocarbon radical.

19. The perfumed consumer product according to claim 1, wherein the particle is a granule, wherein the pro-perfume compound or the trigger is dispersed or adsorbed in a matrix or carrier being a water soluble material comprising a polymeric carrier material selected from the group consisting of urea, polyvinyl acetates, polyvinyl alcohol, dextrins, maltodextrins, glucose syrups, natural or modified starch, polysaccharides, carbohydrates, chitosan, gum Arabic, polyethylene glycol (PEG), polyvinyl pyrrolidone, polyvinyl alcohol, acrylamides, acrylates, methacrylate, polyacrylic acid, maleic anhydride copolymers, amine-functional polymers, polyvinyl benzyl chloride, vinyl ethers, styrenes, polystyrenesulfonates, vinyl acids, ethylene glycol-propylene glycol block copolymers, vegetable gums, gum acacia, pectins, xanthanes, alginates, carragenans, cellulose or cellulose derivatives, carboxymethyl methylcellulose, methylcellulose, ethylcellulose, propylcellulose, hydroxyethyl cellulose, polyols/sugar alcohols, sorbitol, maltitol, xylitol, erythritol, isomalt, PVP, citric acid or any water soluble solid acid, fatty alcohols or fatty acids and mixtures thereof.

20. The perfumed consumer product according to claim 1, wherein the particle is a granule, wherein the pro-perfume compound or the trigger is dispersed or adsorbed in a matrix or carrier being a water soluble material comprising an inorganic material selected from the group consisting of sodium chloride, sodium sulphate, sodium acetate, zeolite, sodium carbonate, sodium bicarbonate, clay, talc, calcium carbonate, magnesium sulfate, gypsum, calcium sulfate, magnesium oxide, zinc oxide, titanium dioxide, calcium chloride, potassium chloride, magnesium chloride, and zinc chloride.

21. The perfumed consumer product according to claim 1, wherein the particle is a microcapsule being a hybrid shell composed of at least two types of inorganic particles that are cross-linked, or a shell resulting from the hydrolysis and condensation reaction of a polyalkoxysilane macro-monomeric composition.
